(19) United States
(12) Patent Application Publication
(10) Pub. No.: US 2007/0093943 A1
(43) Pub. Date: Apr. 26, 2007

(54) System and method for remote convenience vehicle telematics

(76) Inventors: Scott Nelson, Redondo Beach, CA (US); Masayuki Habaguchi, Utsunomiya-shi (JP)

Correspondence Address: HONDA/FENWICK, SILICON VALLEY CENTER, 801 CALIFORNIA STREET, MOUNTAIN VIEW, CA, 94041, US

(21) Appl. No.: 11/446,066

(22) Filed: Jun. 1, 2006

Related U.S. Application Data
(60) Provisional application No. 60/686,661, filed on Jun. 1, 2005.

(51) Int. Cl. G06F 17/00

(52) U.S. Cl. 701/2

(57) ABSTRACT

A system comprises a satellite broadcasting a signal including a remote convenience telematics command, a user interface system providing the remote convenience telematics command to the satellite in response to user input, and a vehicle system for performing a remote convenience task in response to a received broadcast signal. The vehicle system is in a sleep mode in response to a vehicle turn off signal and is in a monitoring mode during predetermined time intervals after the vehicle turn off signal or in response to a user input. The vehicle system monitors for receipt of the broadcast signal during the monitoring mode. The predetermined time intervals have a duration so that the vehicle system has a predetermined probability of detecting the broadcast signal.

### CROSS REFERENCE TO RELATED APPLICATIONS

This application claims the benefit of U.S. Provisional Application No. 60/686,661, filed Jun. 1, 2005, which is incorporated by reference in its entirety.

### BACKGROUND

1. Field of Art

The present invention generally relates to satellite communications, and more specifically, to remote service systems using one way satellite communications.

2. Description of the Related Art

Telematics, the blending of computers and wireless telecommunications technologies, seeks to convey information over vast networks to provide a host of business or public services. The term has evolved to refer to automobile systems that make use of wireless communications to provide driver assistance and remote diagnostics. Conventional vehicular telematics systems make use of two-way wireless communications, typically cellular or two-way radio communications or paging.

From the above, there is a need for a system and process to provide driver assistance that uses less complex communications.

### SUMMARY

A system comprises a satellite broadcasting a signal including a remote convenience telematics command, a user interface system providing the remote convenience telematics command to the satellite in response to user input, and a vehicle system for performing a remote convenience task in response to a received broadcast signal.

In one embodiment, the vehicle system is in a sleep mode in response to a vehicle turn off signal and is in a monitoring mode during predetermined time intervals after the vehicle turn off signal or in response to a user input. The vehicle system monitors for receipt of the broadcast signal during the monitoring mode. The predetermined time intervals have a duration so that the vehicle system has a predetermined probability of detecting the broadcast signal.

In one embodiment, the vehicle system comprises a satellite broadcast receiver for receiving a broadcast signal including remote convenience telematics commands. A host processing module determines a remote convenience task corresponding to the received command. A controller performs the remote convenience task in a vehicle in response to the remote convenience telematics commands.

In one embodiment, the user interface system provides uplink data to the satellite. The user interface system comprises a user interface for receiving a user request for a remote convenience service. A broadcast manager determines timing of a remote convenience telematics command for inclusion in the uplink data to the satellite. An uplink system provides an uplink data signal including the remote convenience telematics command to the satellite vehicle system for broadcast to a vehicle for execution of the remote convenience service.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF DRAWINGS

The disclosed embodiments have other advantages and features which will be more readily apparent from the following detailed description and the appended claims, when taken in conjunction with the accompanying drawings, in which:

FIG. 1 is a block diagram illustrating one embodiment of a remote convenience telematics vehicle system according to the present invention.

FIG. 2 is a flowchart illustrating a methodology of the remote convenience telematics vehicle system of FIG. 1 according to the present invention.

FIG. 3 is a state diagram illustrating timed wake-up cycles of the remote convenience telematics vehicle system of FIG. 1 according to the present invention.

FIG. 4 is a timing diagram of the timed wake-up cycles of the state diagram of FIG. 3 according to the present invention.

FIG. 5 is a flowchart illustrating a methodology of processing a user initiated wake-up of the vehicle of the remote convenience telematics vehicle system of FIG. 1 according to the present invention.

### DETAILED DESCRIPTION

The Figures and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments, examples of which are illustrated in the accompanying figures. It is noted that wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles described herein.

Generally, the disclosed embodiments describe a vehicle system that receives remote convenience telematics commands from one-way satellite broadcast communications. A user communicates over a second communication system, such as telephone or Internet, to a vehicle telematics control system to set desired remote convenience services for the user's vehicle.

The “remote convenience” (RC) services are flexible, and accommodate a number of operational scenarios. For example, the user may have i) locked his keys in his car, ii) forgot to lock his car, iii) forgot where he parked his car (such as in a vast parking lot), or iv) want to disable the vehicle. The user can request remote convenience services while near the vehicle by way of cell phone or pager-type device or remote from the vehicle, e.g., at a kiosk or computer. Such services can include unlock, lock, turn on/off lights, honk horn, set a panic alert or car-finder service, or disable/immobilize the vehicle. Furthermore, a service can be sub-specified to do more specific tasks. For example, unlock may unlock one door, all doors, or open the trunk. Furthermore, the available remote convenience services, by design of the protocol, are only limited to those vehicle functions accessible by the HPM via the vehicle bus or wired interface. The protocol can pass through any commands available at such interface, thereby not limiting the service to those previously listed.

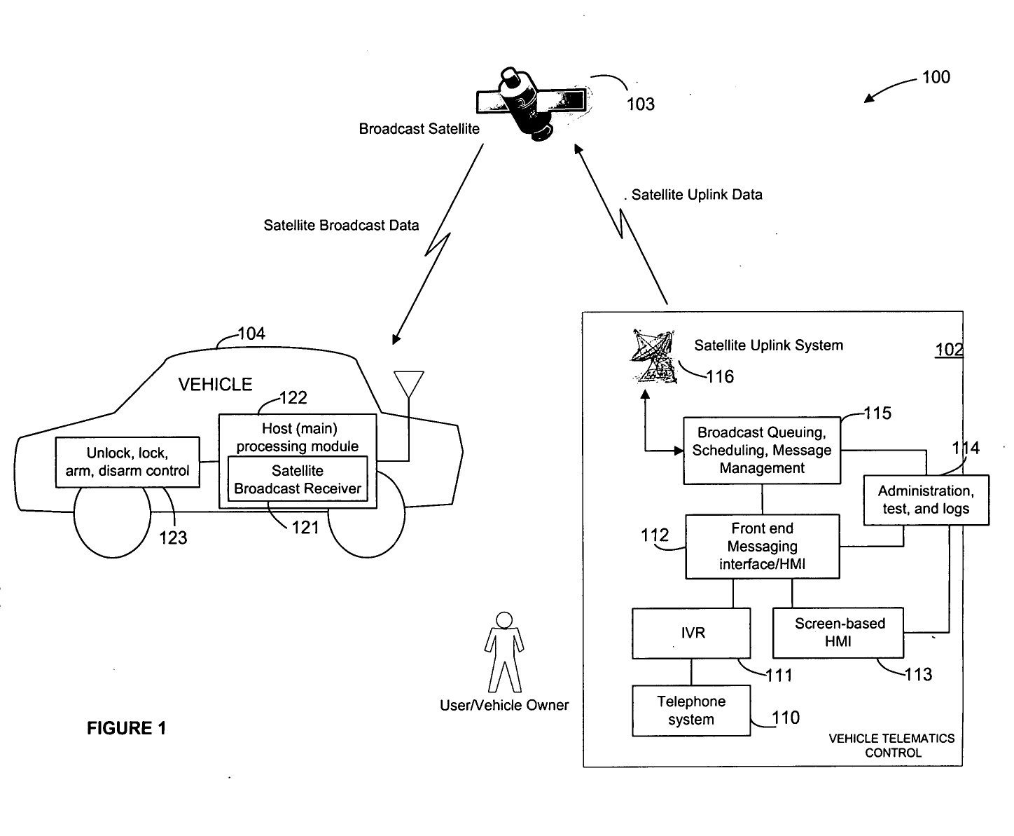

FIG. 1 is an illustration of the environment in which one embodiment of the present invention operates. In this system, the participants “user” and “owner” may be considered interchangeable, provided that a non-owner “user” is authorized by the owner of the vehicle. A remote convenience vehicle telematics system 100 comprises a vehicle telematics control system 102, a broadcast satellite 103, and a vehicle 104. The vehicle telematics control system 102 includes the user interface to a satellite uplink system to receive user requested for remote convenience services. The vehicle 104 includes the electronics and mechanics associated with the remote convenience telematics. The broadcast satellite 103 provides one-way communications of commands for remote convenience telematics services from the vehicle telematics control system 102 to the vehicle 104.

The vehicle telematics control system 102 comprises a telephone system 110, an interactive voice response (IVR) subsystem 111, a front end messaging interface 112, a screen-based human message interface (HMI) 113, an administrative subsystem 114, a broadcast management subsystem 115, and a satellite uplink system 116.

The interactive voice response subsystem 111 is used to field calls from the telephone system 110 (e.g., a traditional analog phone, PBX, voice-over-Internet Protocol (VoIP) system, or direct interface with a wireless telephone system) for requesting remote convenience services. The interactive voice response subsystem 111 serves those calls with voice prompted instructions, and can interpret user speech commands and presses of DTMF digits on a telephone keypad. The interactive voice response subsystem 111 can also transfer calls to other telephone lines or systems.

The screen-based human machine interface subsystem 113 provides the user with a screen-based interface, such as a kiosk, web browser, or other terminal device such as a mobile client device, for requesting remote convenience services.

Through either the interactive voice response subsystem 111 or the screen-based human machine interface subsystem 113, the user is first identified and authenticated. The user can then initiate the remote convenience services described above. The user can also check the status of the vehicle telematics control system 102. For example, the user can view or change settings related to the user's account or services.

The front-end human messaging interface (HMI) 112 handles communications between either of the interactive voice response subsystem 111 or the screen-based HMI 112 and the administrative subsystem 114, the broadcast management subsystem 115, and the satellite uplink system 116.

The broadcast management subsystem 115 prepares and sends messages for the remote convenience services to the broadcast satellite 103 through the satellite uplink system 116. Messages are managed and scheduled for sending based on such factors as priority, device availability, user inputs, system load, other messages currently being broadcast, and the timing of message delivery to the vehicle. The messages can be targeted for delivery to a particular vehicle according to a unique identifier, such as vehicle identification number (VIN). The unique identifier can be directly provided by the user, assuming that authentication/validation criteria have been satisfied. Alternately, the unique identifier can be determined by the vehicle telematics control system 102, based on the user's identity and the identity of a vehicle stored in the system and associated with the user.

In one embodiment, the front end messaging interface 112 and the broadcast management subsystem 115 can i) check for sufficient user account “credits” prior to fully executing the service, ii) elect to bill the user according to stored billing information, or iii) prompt the user for billing credentials in order to charge on a pay-per-use basis.

The administrative subsystem 114 provides for administration of the system 100, e.g., for internal operations, logs, maintenance, test or diagnosis. The administrative subsystem 114 may also serve as a point of contact for privileged access by, e.g., customer service agents or vehicle dealerships.

The interactive voice response (IVR) subsystem 111, the front end messaging interface 112, the screen-based human message interface (HMI) 113, the administrative subsystem 114, and the broadcast management subsystem 115 may be implemented by equipment including individual desktop computers, clusters of computers, mainframes, distributed networks of computers or computing resources, or other types of hardware and software resources.

The satellite uplink system 116 sends messages intended for broadcast by the satellite 103. Although one broadcast satellite 103 is shown, other numbers of broadcast satellites 103 may be used. Any satellite system may be used that is capable of broadcasting to the vehicle. According to one embodiment, the uplink system of a Satellite Digital Audio Radio Service (SDARS), such as the XM Satellite Radio service, is used. In one embodiment, the remote convenience telematics commands are time division multiplexed into satellite uplink data. The satellite uplink system 116 sends satellite uplink data to the broadcast satellite 103.

The broadcast satellite 103 broadcasts the satellite uplink data to a plurality of vehicles 104. Although one vehicle 104 is shown, other numbers of vehicles 104 may be used. The remote vehicle telematics command includes a unique identifier as described above for the vehicle 104 of the user requesting the remote convenience service.

The vehicle 104 receives the broadcast satellite data stream and processes the remote convenience telematics commands in the data stream that are addressed to the vehicle. The vehicle 104 comprises a host processing module 122 and a controller 123.

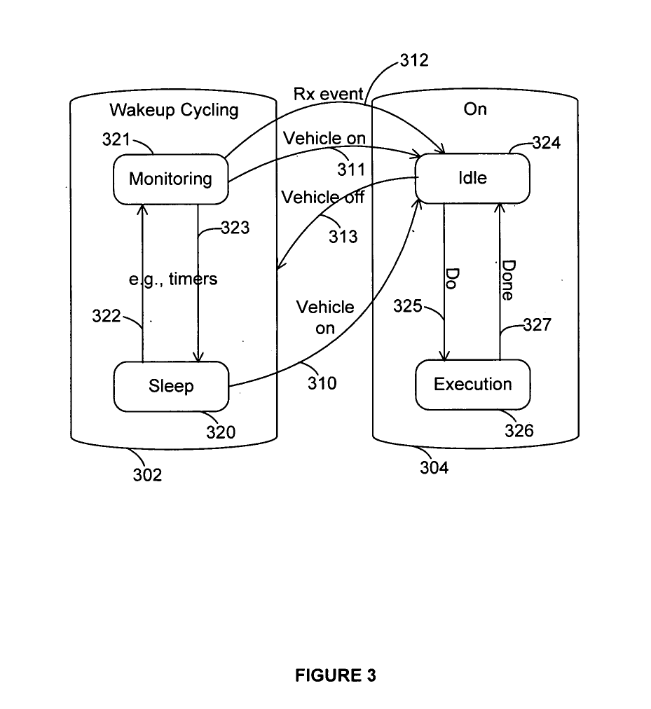

The host processing module 122 detects an applicable data broadcast. The host processing module 122 can automatically “wake up” from a power-save mode (described in detail below in conjunction with FIG. 3) to fully receive such a broadcast, or can be triggered to do so by the user (e.g., through an external input device accessible by the user). The host processing module 122 may filter, store, or discard messages that are not considered unique, relevant, timely, authenticated, or intended for the receiving vehicle.

The host processing module 122 includes a satellite data broadcast receiver 121 that receives the broadcast radio signal, decodes the data stream, and communicates the decoded data to the balance of the host processing module 122. In one embodiment, the satellite data broadcast receiver is external to the host processing module 122.

The host processing module 122 decodes a request for some action to determine whether the action is applicable, appropriate, necessary, and otherwise meets requirements. If these tests are met, the host processing module 122 signals the action to the following portion, either directly or via a vehicle bus (not shown).

The controller 123 may be a mechanical and/or electrical module, and performs a remote convenience service action, such as lock, unlock, signal a human message interface, make an alert, arm a system, and/or disarm a system, based upon the received remote convenience telematics command. The controller 123 may also communicate with the host processing module 122 to determine operations or signaling to the user such as vehicle lights, LEDs, displays, or audible devices to indicate status or progression of the service.

In one embodiment, the user may interact again with the vehicle telematics control system 102 to communicate success or failure, or to check the status of any remote convenience service request. The vehicle telematics control system 102 may interpret the user inaction to perform additional actions, such as rebroadcast, alter timing, or cancel broadcast.

The host processing module 122, the satellite data broadcast receiver 121, and the controller 123 may be implemented by any combination of instruction-set processors, dedicated hardware, software or firmware, and mechanical apparatus.

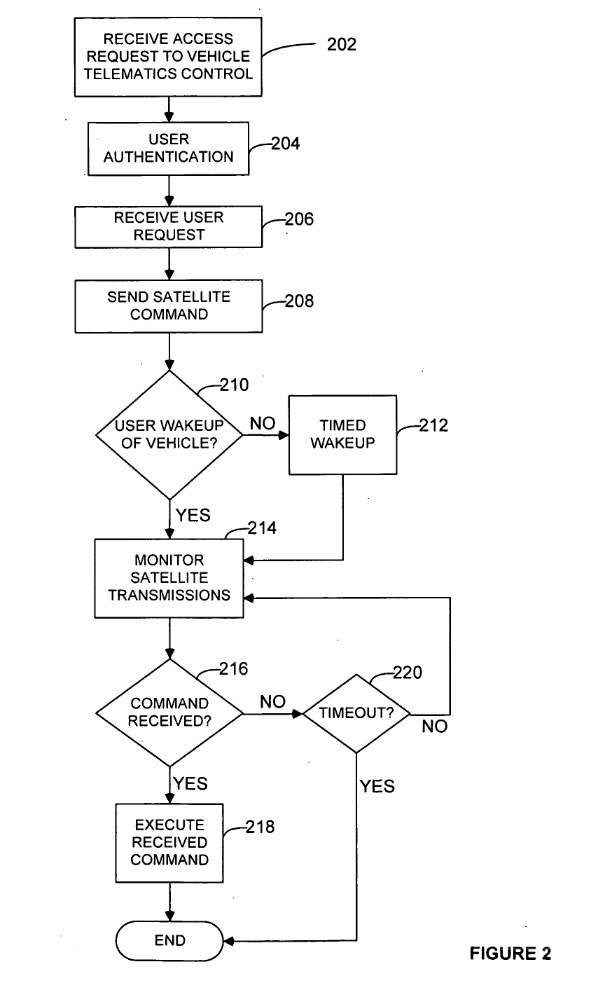

FIG. 2 is a flowchart illustrating one embodiment of a methodology of the remote convenience telematics vehicle system 100. The vehicle telematics control system 102 receives 202 an access request from the user. When a remote convenience service is desired, the user calls a number specific to the services through the telephone system 110 to the interactive voice response subsystem 111 or logs into an appropriate website for a screen-based messaging interface 113.

The front-end messaging interface 112 prompts the user to supply identification, for example, user name and personal identification number (PIN). The front-end messaging interface 112 authenticates 204 the user based on authentication criteria applied to the received information. If the user account includes multiple vehicles, the front-end messaging interface 112 accesses a stored list of possible vehicle identification numbers. The user can then choose a vehicle from the list by any appropriate interactive means.

The front-end messaging interface 112 prompts the user with a list of remote convenience options. The front-end messaging interface 112 receives 206 a user request from the interactive voice response subsystem 111 or the screen-based messaging interface 113. For example, the user may choose to unlock a vehicle 104. In one embodiment, the vehicle telematics control system 102 queries whether the user is currently at or near the vehicle 104. If not, the vehicle telematics control system 102 queries the user for the estimated time for the user to return to the vehicle. The message management subsystem 115 then estimates the optimum time to broadcast the necessary messages via the satellite uplink system 116 and the broadcast satellite 103. This timing estimation depends in part on the scheduling in the uplink and on the current mode of the vehicle 104. The message management system 115 sends 208 the appropriate commands through the satellite uplink system 116 to the broadcast satellite 103 for transmission.

The vehicle 104 may enter a power saving mode (e.g., “sleep” or “hibernation” mode) after a specified period inactivity to avoid excessively draining the battery of the vehicle 104. If the vehicle 104 is in a power saving mode, the vehicle 104 determines 210 whether the user has woken up the vehicle 104; otherwise the vehicle 104 waits 212 for a timed wake-up. The user wake-up and time wake-up are described below in conjunction with FIG. 3. When awake, the host processing module 122 monitors 214 satellite transmissions and determines whether a command is received 216 in a transmission. If a command is received, the host processing module 122 executes 218 the received command by sending the appropriate signals to the controller 123. Otherwise if no command is received 216 the host processing module 122 waits 122 for a time-out to receive remote convenience service commands. If a timeout 122 occurs, the vehicle 104 enters the power saving mode as next described.

FIG. 3 is a state diagram illustrating wake-up cycles of the remote convenience telematics vehicle system 100. In order to receive remote convenience messages from a satellite 103, the satellite broadcast receiver 121 is in a hibernation mode that sufficiently powers the satellite broadcast receiver 123 to receive messages, and to signal the host processing module 122 to act on the received messages. The vehicle 104 operates in a wake-up cycle state 302 or in an on state 304. The vehicle 104 changes from a wake-up cycle state 302 to the on state 304 in response to a vehicle turned on events 310 or 311 or from a transmit event 312 from the satellite broadcast data. The vehicle 104 changes from the on state 304 to the wake-up cycle state 302 in response to a vehicle off event 313 that is generated when the vehicle 104 is turned off.

In the wake-up cycle state 302, the host processing module 122 is in a sleep-state 320 and may switch to a monitoring state 321, which is a wake-up state in response to a wake-up event 322, which may be a periodic wake-up from the sleep mode or user action, such as lifting up the door handle of the vehicle 104. During the monitoring state 321, the host processing module 122 checks for sufficient signal strength from the satellite 103 and issues a confirmation. For example, the vehicle lights may flash or the horn or some other device may beep. In response to a time-out event 323, the host processing module 122 goes into the sleep-state 323.

The wake-up event 322 and the sleep event 323 may be orchestrated by a clock/timing device (e.g., a “real-time clock”). For example, the electronics may be awake during one of every ten minutes. In one embodiment, to further limit battery drain, the remote unlock service may be disabled, e.g., 24 hours after the user leaves the vehicle, by discontinuing the periodic wakeup. The timing associated with periodic wakeup may be adjusted to balance availability of remote convenience services with power consumption. The availability of remote convenience services can be improved by supplementing or replacing periodic wakeup with a user-induced wakeup. This may be implemented in cases that the user can physically interact with the vehicle 104, such as by actuating some electrical switch attached in some manner to the vehicle 104. In such cases, rather than sending messages for a longer time at a lower rate (to save bandwidth), the system could send messages at a higher rate over a shorter time. Periodic and user-induced wakeup may be implemented exclusively or in combination. For example, a particular type of vehicle may not have a switch suitable for user interaction, in which case only periodic wakeup would be used. On the other hand, if only remote unlock service and a switch are provided, only user-induced wakeup may be used. Both periodic and user-induced wakeup may be provided if the offered remote conveniences support and benefit from both wakeup mechanisms. The vehicle telematics control system 102 provides instructions to the user regarding user initiated wake-up procedures, and any action that the use can take to wake-up the vehicle 104 and to confirm the wake-up to the system 102.

During the monitoring state 321, the host processing module 122 goes to an idle state 324 from the on state 304 in response to a vehicle on event 311 or a received event 312. The host processing module 122 remains in the idle state 324 until the vehicle is turned off for a vehicle off event 313 or a remote convenience command 325 is detected. In response to the remote convenience command 325, the host processing module 122 enters an execution state 326 to execute the requested function and after execution 327 enters the idle state 324.

Referring again to FIG. 2, the timing of the send 208 the satellite command, the monitor 216 of the satellite transmissions and executes 218 the received command are scheduled because the system 100 is a one-way, e.g., broadcast system. The message management subsystem 115 determines the appropriate time to insert messages into the broadcast data stream. In the present example, the appropriate time to insert and possibly reinsert messages is determined based upon the estimated times for i) the user to return to the vehicle (if the user is not at or near the vehicle), ii) the user to confirm the intent to wake up and iii) the host processing module 122 to wakeup.

For example, unlock commands may be sent every 3 seconds for up to 10 minutes. The host processing module 122 acts upon the first-received command message and ignores subsequent duplicate messages. Multiple messages are sent to provide immunity to dropouts in the satellite signal and to accommodate uncertainty in message timing. Such timing uncertainty may arise in part if the satellite uplink system “pulls” rather than “pushes” messages. In other words, the design is such that messages may be queued until an opportunity arises for them to be accepted by the satellite uplink system, to accommodate the possibility of uncertainty as to when such acceptance will occur.

Additional timing uncertainty is introduced by the broadcast process itself. For example, even if a message could be “pulled” within an acceptable or expected period of time, the vehicle telematics control system 102 may have difficulty determining an exact message schedule based upon uncertainty, for example, as to when the vehicle 104 will be awake. The vehicle telematics control system 102 therefore may not precisely determine an appropriate time of message delivery to the vehicle 104. Message repetition may be used, and the repetition interval is selected to balance effectiveness and reliability of service with bandwidth limitations and other constraints, such as vehicle battery drain.

Each command message includes a time-of-creation stamp. In one embodiment, the host processing module 122 will not respond if the message is “stale,” e.g., if is received more than 20 minutes after the time stamp. This protects against the possibility that the user's situation has changed since the user issued the unlock command. The time period for determining staleness may be set by the user or the system 102.

After the vehicle is unlocked, the user may confirm, either immediately (if able to do so, e.g., if the user is still connected by phone), or subsequently (e.g., the user calls back). If the user confirms, broadcasting ceases, so that bandwidth is conserved. If the user is at the vehicle 104 and confirms, the associated messages can be scheduled for broadcast immediately, or nearly so (e.g., the delay only involves a period of sustained user-vehicle physical interaction and time to wake the host processing module 122).

The system message timing may be designed to provide a specified minimum quality of service while satisfying bandwidth restrictions. For example, message timing may be designed so that the maximum time-to-unlock is 10 minutes in 99% of cases, and 20 minutes in 99.99% of cases, without exceeding bandwidth limitations.

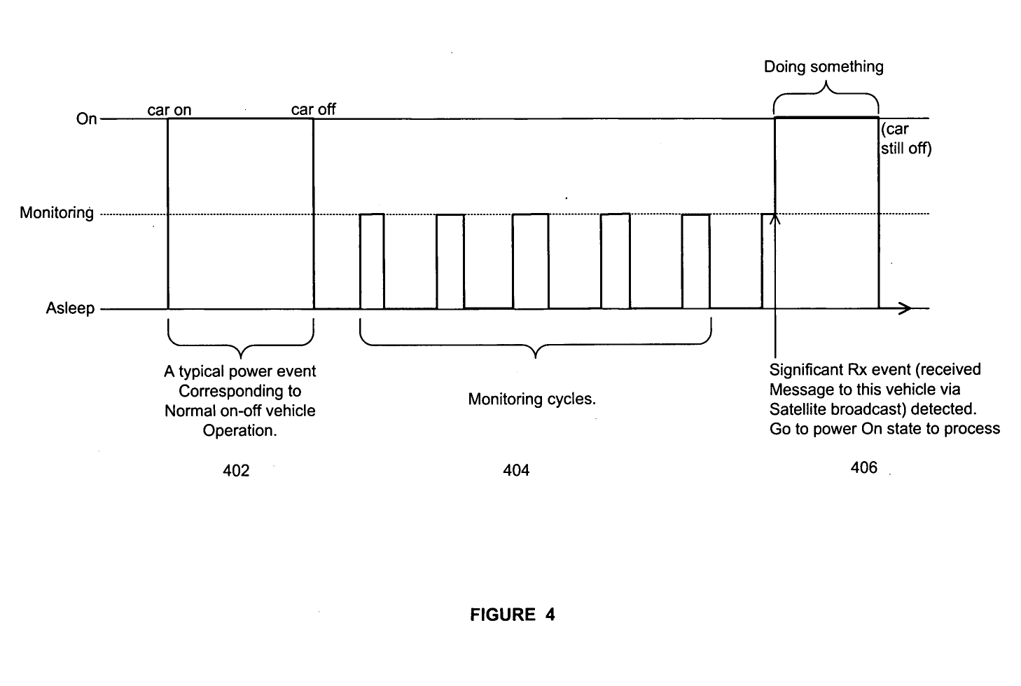

FIG. 4 is a timing diagram of timed wake up cycles of the vehicle 104 corresponding to the timed events 322 and 323 of FIG. 3. During a time period 402, the host processing module 122 is in the on state 304, because the vehicle 104 is turned on. After the vehicle is turned off (vehicle off event 313), the host processing module 122 is in the wake up cycling state 302, and more particularly goes to the sleep state 320. During a monitoring period 404, a series of wake up events 322 switches the host processing module 122 into the monitoring state 321. If no command is received 216 (received event 312), the host processing module 122 goes into the sleep state 320 until the next wake up event 322. As described above, the monitoring 404 continues for a predetermined time-out or until a receive event 312 occurs which is shown in FIG. 4 as time 406. The monitoring cycles need not be linear or fixed (e.g., could be algorithmically-based), and may use global positioning satellites (GPS) time to correct for clock drift. During time 406, the host processing module 122 is in the on state 304 and processes the remote convenience command as described above in conjunction with FIG. 3.

A user initiated wake-up of the vehicle 104 is next described.

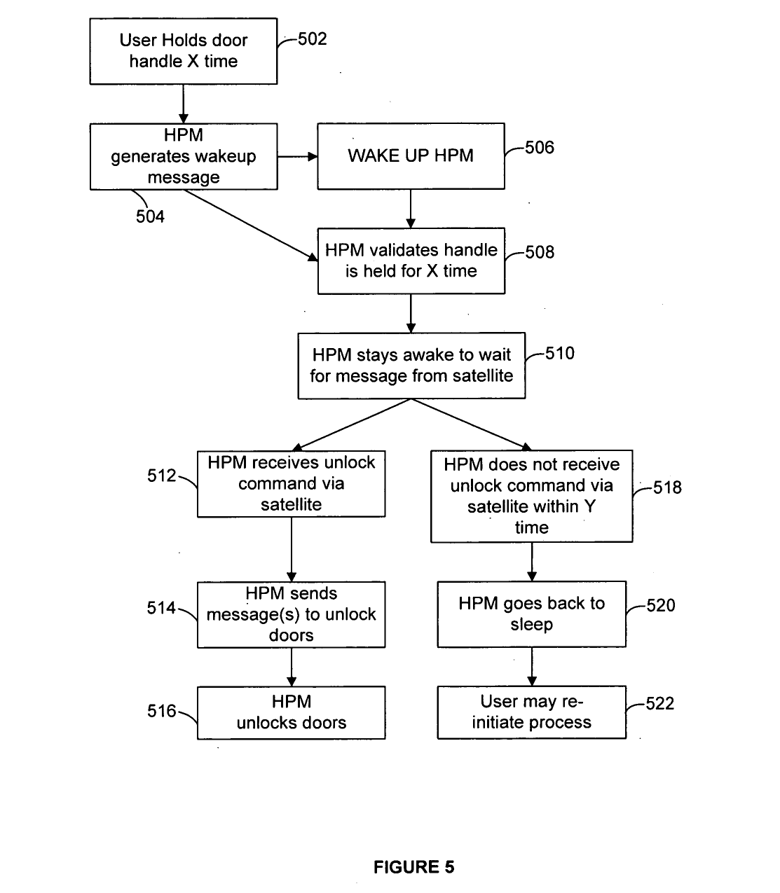

FIG. 5 is a flowchart illustrating a methodology of processing a user initiated wake-up of the vehicle 104. The user holding 502 the door handle for a predetermined time indicates a wake-up of the host processing module 122. As noted above, switches other than a door handle switch can be used for user-initiated wake-up (the door handle being an easily understood illustration). The host processing module 122 generates 504 a wake-up message to switch from the sleep state 320 to the monitoring state 321. The host processing module 122 completely wakes up 506. The host processing module 122 validates 508 that the handle has been held for the predetermined time. The host processing module 122 is awake 510 to wait for a message from a satellite 103 in the monitoring state 321. If the host processing module 122 receives 512 an unlock command from the satellite 103, the host processing module 122 sends 514 messages to the controller 123 to unlock the doors, and the controller 123 unlocks 516 the doors. On the other hand, if the receive command 312 is not received 518 within another predetermined time, the host processing module 122 times out and returns 520 to the sleep mode 320, until the user reinitiates 522 the process by holding the door handle.

In one embodiment, if an expected user-vehicle physical confirmation is not recognized following an unlock request, the host processing module 122 may assume that the user in fact does not wish to unlock the vehicle. Alternately, the host processing module 122 may interpret such a situation as arising from fraud or other foul play. Optionally, the host processing module 122 may then cancel the requested action or revert to another remote convenience service. For example, the host processing module 122 may assume that the user actually forgot where he parked his vehicle 104, and accordingly may command the vehicle horn to honk, or to otherwise signal so that user can locate the vehicle 104.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the invention. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for remote convenience vehicle telematics through the disclosed principles herein. Thus, while particular embodiments and applications have been illustrated and described, it is to be understood that the present invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention as defined in the appended claims.

What is claimed is:

1. A system comprising:
a satellite broadcasting a signal including a remote convenience telematics command;
a user interface system providing the remote convenience telematics command to the satellite in response to user input;
a vehicle system for performing a remote convenience task in response to a received broadcast signal.

2. The system of claim 1 wherein the remote convenience telematics command includes unlocking door of a vehicle.

3. The system of claim 1, wherein the vehicle system is in a sleep mode in response to a vehicle turn off signal and is in a monitoring mode during predetermined time intervals after the vehicle turn off signal, the vehicle system monitoring for receipt of the broadcast signal during the monitoring mode.

4. The system of claim 3 wherein predetermined time intervals have duration so that the vehicle system has a predetermined probability of detecting the broadcast signal.

5. The system of claim 1, wherein the vehicle system is in a sleep mode in response to a vehicle turn off signal and is in a monitoring mode during predetermined time intervals after the vehicle turn off signal or in response to a user input to a device on a vehicle including the vehicle system, the vehicle system monitoring for receipt of the broadcast signal during the monitoring mode.

6. The system of claim 5 wherein predetermined time intervals have duration so that the vehicle system has a predetermined probability of detecting the broadcast signal.

7. The system of claim 5 wherein the vehicle system generates an acknowledgement signal in response to the user input.

8. The system of claim 1 wherein the remote convenience telematics command includes locking a door of a vehicle.

9. A vehicle system comprising:
a satellite broadcast receiver for receiving a broadcast signal including remote convenience telematics commands;
a host processing module for determining a remote convenience task corresponding to the received command;
a controller for performing the remote convenience task in a vehicle in response to the remote convenience telematics commands.

10. The system of claim 9 wherein the remote convenience telematics commands include unlocking door of a vehicle.

11. The system of claim 9, wherein the host processing module is in a sleep mode in response to a vehicle turn off signal and is in a monitoring mode during predetermined time intervals after the vehicle turn off signal, the host processing module monitoring for receipt of the broadcast signal during the monitoring mode.

12. The system of claim 11 wherein predetermined time intervals have duration so that the host processing module has a predetermined probability of detecting the broadcast signal.

13. The system of claim 9, wherein the host processing module is in a sleep mode in response to a vehicle turn off signal and is in a monitoring mode during predetermined time intervals after the vehicle turn off signal or in response to a user input to a device on a vehicle coupled to the vehicle system, the host processing module monitoring for receipt of the broadcast signal during the monitoring mode.

14. The system of claim 13 wherein predetermined time intervals have duration so that the host processing module has a predetermined probability of detecting the broadcast signal.

15. The system of claim 14 wherein the host processing module generates an acknowledgement signal in response to the user input and the controller generates a physical manifestation of an acknowledgement in response to the acknowledgement signal.

16. The system of claim 9 wherein the remote convenience telematics commands includes locking a door of a vehicle.

17. A system for providing uplink data to a satellite, the system comprising:
a user interface for receiving a user request for a remote convenience service;
a broadcast manager for determining timing of a remote convenience telematics command for inclusion in the uplink data to the satellite;
an uplink system for providing an uplink data signal including the remote convenience telematics command to the satellite vehicle system for broadcast to a vehicle for execution of the remote convenience service.

18. The system of claim 17 wherein the remote convenience telematics command includes unlocking door of a vehicle.

19. The system of claim 17, wherein the timing of the remote convenience telematics command accounts for a monitoring mode of the vehicle for monitoring for receipt of the broadcast signal.

20. The system of claim 18 wherein the timing of the remote convenience telematics command provides a predetermined probability of the vehicle detecting the broadcast signal.

21. The system of claim 17, wherein the timing of the remote convenience telematics command accounts for a monitoring mode of the vehicle for monitoring for receipt of the broadcast signal or in response to a user input to a device on the vehicle to cause the vehicle to be in the monitoring mode.

22. The system of claim 21 wherein the timing of the remote convenience telematics command provides a predetermined probability of the vehicle detecting the broadcast signal.
